(19) United States
(12) Patent Application Publication
(10) Pub. No.: US 2002/0057542 A1
(43) Pub. Date: May 16, 2002

(54) Impact activated electronic battery kill switch

(76) Inventor: Robert E. Colling, Pocatello, ID (US)

Correspondence Address: PEDERSEN & COMPANY, PLLC, P.O. BOX 2666, BOISE, ID, 83701, US

(21) Appl. No.: 09/920,977

(22) Filed: Jul. 31, 2001

Related U.S. Application Data
(60) Provisional application No. 60/222,275, filed on Jul. 31, 2000.

(51) Int. Cl. H02H 9/00

(52) U.S. Cl. 361/52

(57) ABSTRACT

The device is an ELECTRONIC BATTERY KILL SWITCH mounted within or associated with a vehicle energy source. Electronic circuitry shuts down chemical energy flow from the battery plates to the battery posts or terminals in a collision, or when optionally linked device(s) deploy, trip or activate.

### DESCRIPTION

This application claims priority of prior, co-pending application Ser. No. 60/222,275, filed Jul. 31, 2000, which is herein incorporated by this reference.

### BACKGROUND OF THE INVENTION

1. Field of the Invention

This invention relates to vehicle electrical systems. It disables electrical power provided by a battery to a vehicle's electrical system to reduce the risk of fire or explosion after an accident or similar catastrophic event.

2. Related Art

The combination of electricity and flammable materials presents a significant hazard. Many patented devices address the inherent risk of an arc induced explosion in/around a vehicle when an impact concurrently ruptures a vehicle's fuel delivery system and an electrical component. These patented devices include:

Plevjak (U.S. Pat. No. 4,195,897) is a COLLISION ACTIVATED, AUTOMATIC ELECTRICITY DISCONNECTOR FOR VEHICLES with a base disconnect device that completes an electrical circuit between a battery and vehicle. A weighted contact rests within the base that dislodges to interrupt the circuit in a collision.

The SAFETY SWITCH FOR VEHICLE ELECTRICAL SYSTEM Emenegger (U.S. Pat. No. 4,321,438) proposes disconnecting the vehicle's battery from other electrical system components upon impact with another vehicle or object. A pivotal lever arm normally rests in an upright position to close the electrical system circuit. A significant force causes a transverse movement that disrupts the lever and opens the circuit.

Brannen (U.S. Pat. No. 4,524,287) reveals a POST-COLLISION FIRE PREVENTION DEVICE that places a weight in a superior orientated breakable tube. A significant impact breaks the tube and the weight falls to activate a switching mechanism that opens the circuit.

Law (U.S. Pat. No. 4,861,684) presents an ELECTRICAL SAFETY SYSTEM FOR BATTERIES. A weighted disconnect link connects to an internal battery cell jumper. The link bridges the two center cells of the battery with the aid of spring clips. The clips disengage in a high g-force event leaving the vehicle powerless.

Cameron (U.S. Pat. No. 5,034,620) portrays a VEHICLE BATTERY SAFETY SWITCH with a main fuse within a battery. An impact jars the switch into a position that overloads the circuit to blow the fuse.

Busquets (U.S. Pat. No. 5,327,990) describes an INTEGRAL AUTOMATIC SYSTEM FOR PROTECTION AND RESCUE OF OCCUPANTS IN CRASHED AUTOMOBILES. A computerized system senses an accident and shuts down non-essential electrical components to reduce risks of fire or explosion.

Kastner (U.S. Pat. No. 5,337,852) presents a COUPLING FOR INTERCONNECTING HOOD WITH A VEHICLE COMPONENT AND FOR DISCONNECTING A VEHICLE ELECTRIC CIRCUIT DURING A COLLISION. The automobile hood interconnects with a battery kill switch. A hood buckling front end collision shifts the coupling to activate the switch.

Richter, et al. (U.S. Pat. No. 5,535,842) exposes a SAFETY ARRANGEMENT FOR COLLISION-RELATED DISCONNECTION OF AN ELECTRICAL ENERGY SOURCE FROM A MOTOR VEHICLE SUPPLY CIRCUIT. A collision-sensing device initiates the release of propellant energy to partially separate the battery from the motor vehicle. Similarly, Yasukuni, et al. (U.S. Pat. No. 5,990,572) professes an ELECTRIC CIRCUIT BREAKER FOR VEHICLE with explosive media, a detonation device and a collision detection apparatus in a combination that explodes within a positively defined area. The explosion trips a main circuit breaker.

Nieschulz (U.S. Pat. No. 5,574,316) depicts a VEHICLE BATTERY DISABLING APPARATUS controlled by a solenoid. The energized solenoid rests in a retracted position and de-energizes by extending with the aid of a spring loaded plunger actuated by the driver, passenger or rescuer. The solenoid trips an electronic switch that blocks current from the vehicle's electrical system.

Kems, et al. (U.S. Pat. No. 5,602,371) divulges a MOTOR VEHICLE ELECTRICAL SYSTEM DEACTIVATING SWITCH with an electrolytic fluid filled chamber. The fluid completes a circuit that supplies power at a generally horizontal level. The fluid moves to open the circuit and cease power transmission if the vehicle overturns or remains at a critical attitude.

Miyazawa, et al. (U.S. Pat. No. 5,818,122) portrays a POWER SUPPLY CIRCUIT BREAKING APPARATUS FOR MOTOR VEHICLE AND POWER SUPPLY CIRCUIT BREAKING SYSTEM FOR MOTOR VEHICLE. This unit consists of two power supply paths and a circuit breaker. The triggering of an impact switch creates a control signal that trips the circuit breaker.

These devices reduce vehicular fire risks from a collision. Most address the potential for igniting fuels by cutting electrical power at, or relatively near, the exterior portion of the battery. This positioning permits current flow to their cutoff point. As a result, the possibility of an electric arc igniting a fire remains.

Cameron and Law place mechanical switches within the battery forcing the user to open the battery encasement to re-use the battery. Most batteries contain inherently explosive gasses and a single spark in their immediate vicinity could place the individual in a path of deadly peril. For this reason, mechanical means with internal servicing requirements may not be preferred.

The current invention addresses the risk of external kill switches and internal safety systems by placing an IMPACT ACTIVATED ELECTRONIC BATTERY KILL SWITCH within the battery itself.

### BRIEF SUMMARY OF THE INVENTION

The device is an ELECTRONIC BATTERY KILL SWITCH mounted within a vehicle energy source, which may be activated by impact or by other signals. Electronic circuitry interrupts electrical energy flow from the battery plates to the battery terminals when a collision occurs, or when optionally linked device(s) deploy, trip or activate the device.

Upon a vehicular collision, for example, a safety restraint system, usually in the form of an airbag device, provides an electric signal that enters a battery connection port. This signal may pass through a series of resistors, transistors, diodes or capacitors along a signal pathway. The signal ultimately connects to the gate of a silicon controlled rectifier (SCR). The gate signal causes current to flow through the anode and cathode leads of the SCR, which in turn shuts off a metal oxide semiconductor field effect transistor (MOSFET) gate. The SCR acts as an open circuit until receiving the current and then switches to a conducting state. The conducted current passes through a resistor that shunts energy away from the MOSFET, causing its gate to shut off and disabling the battery plate to post connection, which completely turns off the automobile's electrical system.

To reverse the disconnection, an external magnetic card reader, infrared device or radio wave receiver can be employed to reset the SCR thereby permitting closure of the MOSFET circuit and re-establish power to the vehicle's electrical system.

### DRAWINGS DESCRIBED

The figures depict several, but not all, embodiments of the subject IMPACT ACTIVATED ELECTRONIC BATTERY KILL SWITCH device.

FIG. 1 is a schematic circuit diagram for one device embodiment with a single MOSFET.

FIG. 2 is a schematic circuit diagram of one device embodiment with a number of MOSFET's.

FIG. 3 is a schematic circuit diagram of a touch switch circuit.

FIG. 4 is a schematic circuit diagram of an operational amplifier/comparator circuit.

FIG. 5 is a schematic circuit diagram of one device embodiment.

### DETAILED DESCRIPTION OF THE INVENTION

This IMPACT ACTIVATED ELECTRONIC BATTERY KILL SWITCH receives a hard-wired or wireless signal from a vehicle's safety restraint system, indicating a vehicular accident or reasonably severe impact. The signal may derive from an airbag deployment switches or seatbelt force detector(s) such as a weighted pendulum(s), accelerometers, or other devices.

Traditional vehicular batteries include an anode, a cathode and a one or more cells that convert chemical energy into electrical energy. In many battery designs, an electrolyte provides enhanced electrical conductivity through ion disassociation.

Referring to FIGS. 1 & 2: An enhancement-mode type of power MOSFET (metal-oxide silicon field-effect transistor) device (2) is placed in a circuit pathway between a battery (5) negative plate (4) and its external negative terminal post (6). The battery's negative plate (4) connects to the MOSFET source while the negative terminal post (6) is connected to the MOSFET drain.

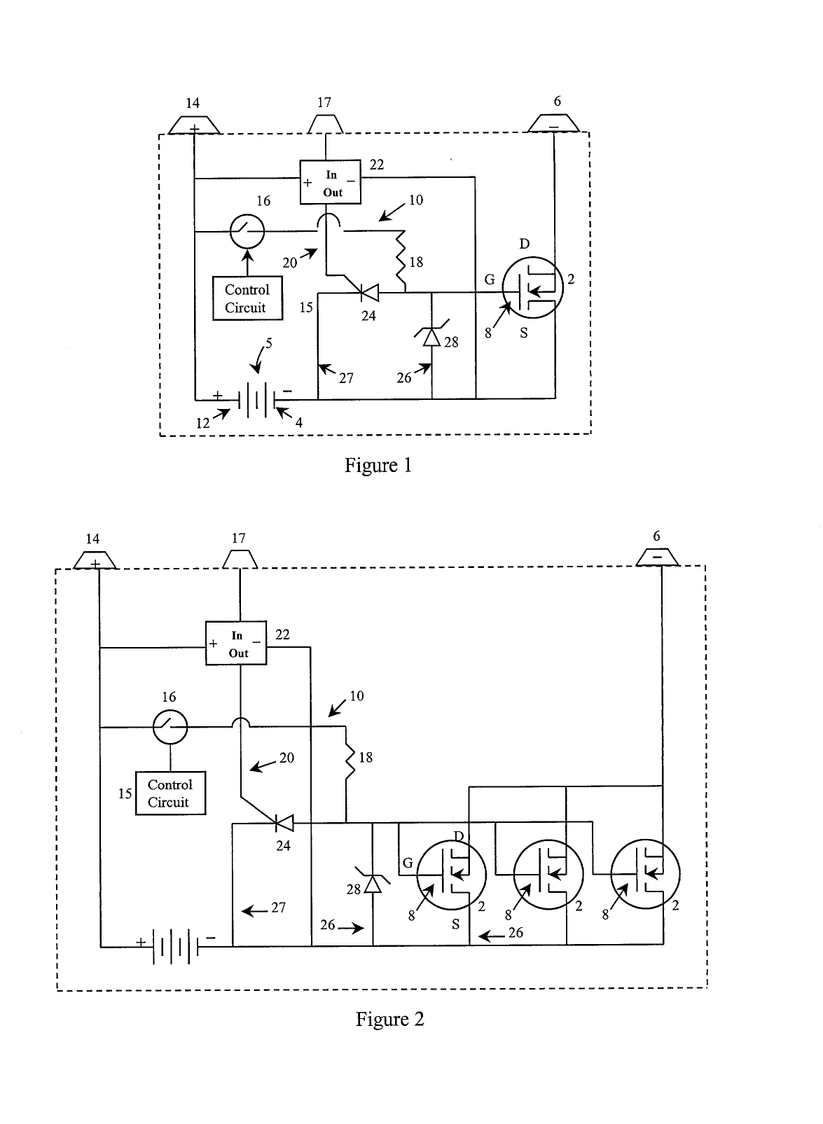

The MOSFET's gate terminal (8) is energized by a second electrical circuit path (10) that draws current from the battery's positive power plate (12) or positive terminal post (14) flowing through switch (16) and positive gate biasing resistor (18). Thus, the energized MOSFET (2) permits current flow from the negative power plate (4) to negative post (6) and provides a useable voltage differential between the battery's negative and positive posts, much as would a typical modern vehicle battery. More than one MOSFET (2) may exist in parallel to serve applications with higher-rated peak amperages, as revealed in FIGS. 2.

Switch (16) resides within the battery (5), and serves to provide a means of energizing the MOSFET gate(s) (8) when a battery is to be in service. Examples of the use of switch (16) to disable a battery (5) include such times as when a vehicle is being serviced, or when a dangerous condition might exist as a result of battery voltage being present. Examples of the use of switch (16) to enable a battery into service include such times as when a battery is first purchased, or when services to a vehicle with a disabled battery are completed.

Switch (16) is energized or de-energized by control circuit (15). Differing embodiments may require physical, thermal energy, static energy, or other stimulus to trigger the control circuit (15), which, in-turn, controls the voltage at the MOSFET gate (8). Alternative switch embodiments may combine with a radio or infrared receiver that would permit a battery shutdown or de-energizing by remote control. Encryption of this frequency and/or a rotating frequency would prevent unauthorized battery shutdown. However, maintaining at least one specific secure frequency, which may be associated with telecommunications technology such as a pager, cell phone or similar receiving apparatus, would assure that law enforcement officers could disable a vehicle's electrical system if an impact event did not trigger shutdown or, if the vehicle's occupant may be engaged in unlawful activity and subject to a search and/or an arrest.

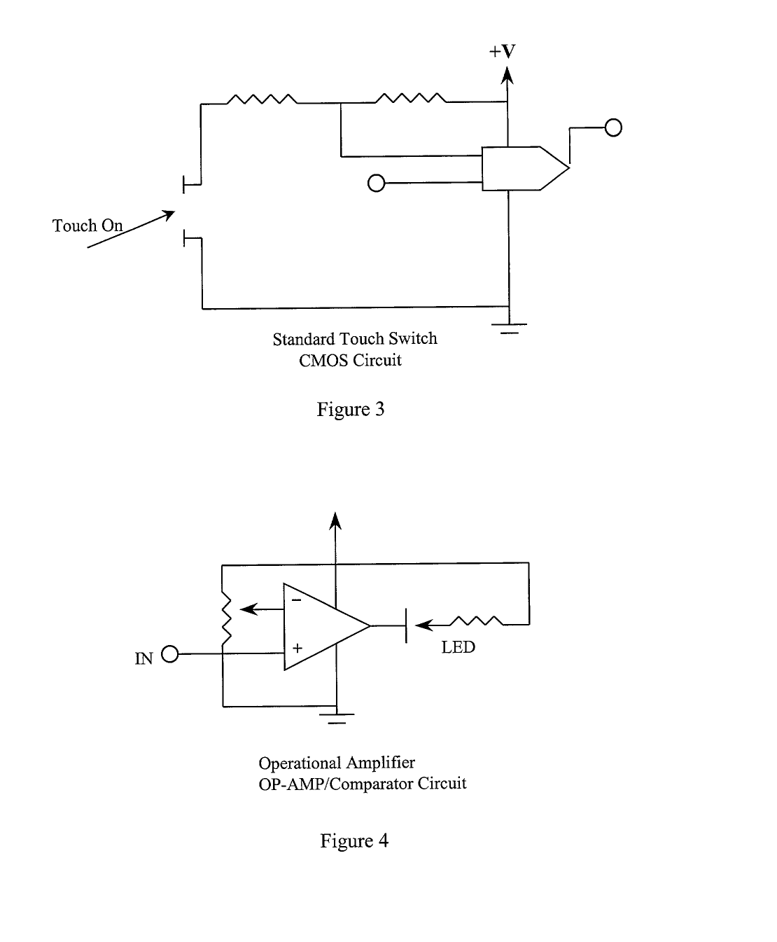

Exemplary forms of switch (16) include an electronic toggle, such as the CMOS touch switch depicted in FIG. 3, a micro-membrane or a similar non-arcing circuit that draws very few microamps of current from the battery's cell(s). The non-arcing circuit is a safety mechanism that reduces the chance of igniting a lead-acid type battery's dissociated Hydrogen gases. In addition, the low power requirement permits the switch to remain in a closed position for an extended period of time without significant battery charge depletion.

Mechanics and other vehicle repair facilities routinely disconnect an electrical system's cables from a battery's terminals to reduce the risk of electric shock or the ignition of volatile fluids. Manually tripping switch (16) also provides a rapid means to achieve the same goals by de-energizing the MOSFET (2) and hence the vehicle's electrical system without requiring additional labor.

Gate biasing resistor (18) reduces the energy derived from second electrical circuit path (10) to limit current drain through MOSFET (2). Its resistance will vary according to the voltage, amperage, number of cells, and number of batteries that comprise the useable voltage differential. For example, the device may be utilized on individual batteries when connecting four six volt batteries in series to produce a twenty-four volt battery circuit. This case would require a gate resistor with a resistance designed to the individual battery's electrical capacity. Alternatively, one battery could have a device embodiment with a gate resistor having a resistance that is capable of supporting the load of all batteries in the series.

### IMPACT DEACTIVATION

Third electrical circuit path (20) arises when a trigger circuit (22) detects a safety system activation. This activation may take the form of one, or more, of the following events: an airbag deployment, onboard computer detection of an abnormal engine or electrical condition, closing of a contact switch circuit located about the vehicle (seatbelt pendulum, body linings), contact with another vehicle or instrument that has a conflicting ground state (negative ground vehicle in contact with a positively charged guy wire or vehicle), a fuel leak detector or a fuel pump experiencing a lack of flow resistance. Other triggering mechanisms may include satellite or local positioning systems or range-finding equipment that provide a signal when an impact occurs or appears eminent. Regardless of the impact detection method, the primary result will be a signal in the form of an electrical current or light wavelength that ultimately provides a pulse to the gate of SCR (24).

In FIGS. 1 & 2, sensor (22) is a circuit that receives the safety system signal at terminal (17), which is amplified and processed with an amplifier/comparator (22) and transmitted to SCR (24). Upon activation of SCR (24), a low-resistance, forward biased connection between anode and cathode overrides the energizing positive electrical current of second electrical circuit path (10). This electrical circuit path serves to shunt the gate of MOSFET (2) to ground, which, in turn de-activates the drain-source MOSFET connection, which, in-turn, effectively disconnects the battery current flow to the negative terminal (6). SCR (24) thereby maintains the de-energized state until circumstances warrant re-energizing the battery by re-connecting the switch (16) through control circuit (15).

FIGS. 3 and 4 are schematic diagrams of a touch switch, and a sensitive amplifier circuit, respectively. In certain embodiments of this invention, the purpose of circuit (22) can be to provide amplification to a small input signal that will assure an adequate electrical current to SCR (24). While an amplifier is not essential to disable the battery, it acts in certain embodiments as a mechanism to modify a small signal from a safety system that provides only a weak pulse of energy upon activation. The example circuits shown in FIGS. 3 and 4 therefore modify an electrical current that would normally not last long enough to trip switch (16) or a signal source that later becomes disabled from the impact itself or other physical or chemical events.

Fourth electrical circuit pathway (26) places a zener diode (28) between the negative power cell(s) (4) and the MOSFET's gate terminal (8) to act as a voltage regulator. Charging a battery by (alternator, generator, photovoltaic panel, jumper cables, battery charger, etc.) typically creates varying voltage demands or surpluses. Zener diode (28) limits the energy from a charge source to prevent damage to the gate terminal (8) of MOSFET (2) while providing enough electrical current to energize the MOSFET (2). The energized MOSFET (2) permits the transfer of negative electrical current from the charge source through the negative exterior oriented post(s) (6) to the negative power cells (4).

The preferred embodiment of the device incorporates switch (16), gate resistor (18) and amplifier into one integrated circuit. The combination of the integrated circuit, the zener diode and the corresponding diode would exist on one printed wiring board that is hard-wired to the battery's appropriate post(s) and terminal(s) either during battery production or as an post-production manufacturing process. Alternative embodiments would provide a connector for rapid insertion or removal of the circuit when the device is sold as an aftermarket product or simply for servicing.

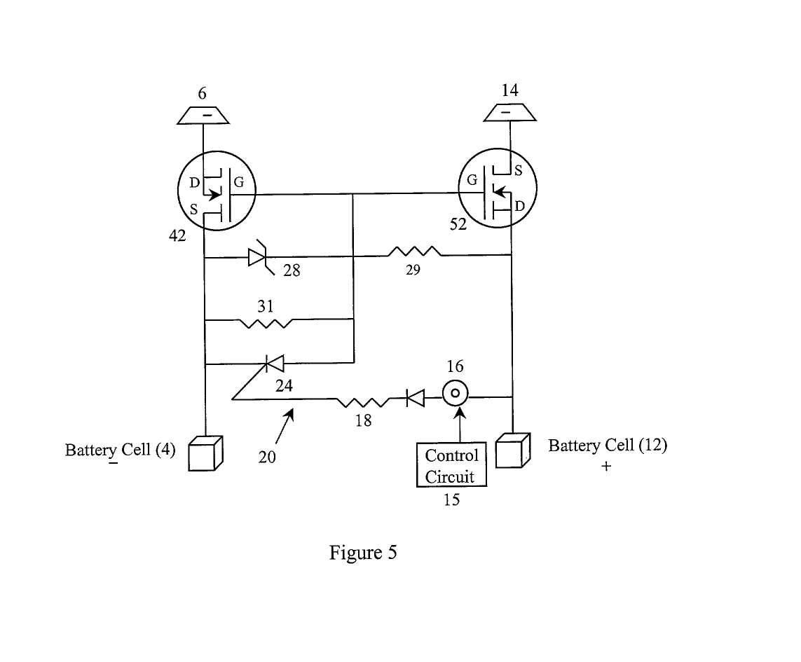

Discussion of this invention above has referenced particular means, materials and embodiments elaborating limited application of this invention. Other types of MOSFET driver circuits (10, 20) and variations of SCR control circuits (15, 16) can be used, which achieve the same result. In addition, reversing polarity controls for positively ground systems is specifically anticipated and, FIG. 5 depicts an embodiment that implements the invention for the negative and positive terminal posts concurrently for a complete current shutdown.

Finally, the invention is not limited to the particulars described above, and applies to all equivalents that may be otherwise described. Although this invention has been described above with reference to particular means, materials and embodiments, it is to be understood that the invention is not limited to these disclosed particulars, but extends instead to all equivalents within the scope of the following claims.

I claim:

1. An electronic battery kill switch system for a vehicle having a vehicle electrical system and having a battery with plates and terminal posts, the kill switch system comprising:
a silicon controlled rectifier having a gate;
a metal oxide semiconductor field effect transistor electrically connected between a battery plate and a battery terminal post, the metal oxide semiconductor field effect transistor being electrically or electronically connected to the silicon controlled rectifier and having a gate;
signal means supplying an emergency signal to said gate of the silicon controlled rectifier, wherein, in response to said emergency signal, said silicon controlled rectifier is adapted to turn off said gate of said metal oxide semiconductor field effect transistor so that the battery plate to terminal post electrical connection is interrupted, wherein the battery is disconnected from said vehicle electrical system.

2. The kill switch system of claim 1, wherein said signal means comprises means for sensing an airbag deployment.

3. The kill switch system of claim 1, wherein said signal means comprises means for sensing an abnormal engine condition.

4. The kill switch system of claim 1, wherein said signal means comprises means for sensing an abnormal electrical condition in said vehicle electrical system.

5. The kill switch system of claim 1, wherein said signal means comprises a switch operatively connected to a seatbelt pendulum for sensing an impact.

6. The kill switch system of claim 1, wherein said signal means comprises means for sensing contact of the vehicle with a conflicting ground state.

7. The kill switch system of claim 1, wherein said signal means comprises means for detecting a fuel leak.

8. The kill switch system of claim 1, wherein said signal means comprises means for sensing a low fuel pump outlet pressure.

9. The kill switch system of claim 1, wherein said signal means comprises means for receiving a signal from law enforcement officials.

10. The kill switch system of claim 1, wherein said signal means comprises means for receiving a signal from a satellite positioning system.

11. The kill switch system of claim 1, wherein said signal means comprises amplification means.

12. The kill switch system of claim 1, wherein said silicon controlled rectifier being adapted to turn off said gate of said metal oxide semiconductor field effect transistor comprises circuitry to shunt the gate of said metal oxide semiconductor field effect transistor to ground so that a drain-source connection of the metal oxide semiconductor field effect transistor is deactivated.

13. The kill switch system of claim 12, wherein deactivation of the drain-source connection of said metal oxide semiconductor field effect transistor disconnects battery current flow from said battery plate to a negative terminal post of the battery.

14. The kill switch system of claim 1, wherein said signal means further comprises a zener diode for protecting the gate of the metal oxide semiconductor field effect transistor from high voltage.

15. The kill switch system of claim 1, wherein said signal means further comprises encryption of a emergency signal to prevent unauthorized battery shutdown.

16. The kill switch system of claim 1, wherein said signal means further comprises a rotating frequency means for preventing unauthorized battery shutdown.

17. The kill switch system of claim 1 further comprising an activation switch with means for energizing the gate of the metal oxide semiconductor field effect transistor when the battery is to be place in service.
